(19) United States
(12) Patent Application Publication
(10) Pub. No.: US 2022/0392088 A1
(43) Pub. Date: Dec. 8, 2022

(54) METHOD, SYSTEM AND COMPUTER-READABLE STORAGE MEDIUM FOR MEASURING DISTANCE

(71) Applicant: FLYTECH TECHNOLOGY CO., LTD., Taipei City (TW)

(72) Inventors: Li-Chun CHOU, Taipei City (TW); Shui-Chin TSAI, Taipei City (TW); Pin-Chieh LIU, Taipei City (TW); Angela Pei Ying LIM, Taipei City (TW)

(21) Appl. No.: 17/477,111

(22) Filed: Sep. 16, 2021

(30) Foreign Application Priority Data
Jun. 8, 2021 (TW) 110120771

(51) Int. Cl. G06T 7/50; G06K 9/00; G06K 9/20

(52) U.S. Cl. CPC G06T 7/50; G06K 9/00281; G06K 9/00248; G06K 9/2063; G06T 2207/30201

(57) ABSTRACT

A method for measuring distance is provided and includes: receiving an image captured by an image capturing device; identifying and extracting a human face in the image; identifying two eyes and a mouth included in the human face; defining a region using the two eyes and the mouth, and calculating a number of pixels contained in the region; and calculating a distance between the human face and the image capturing device based on the number of pixels contained in the region and a resolution of the image capturing device.

### CROSS-REFERENCE TO RELATED APPLICATION

This application claims priority of Taiwanese Patent Application No. 110120771, filed on Jun. 8, 2021.

### FIELD

The disclosure relates to a method, a system and computer-readable storage medium for measuring distance, and more particularly to a method, a system and computer-readable storage medium for measuring distance between a human face and an image capturing device.

### BACKGROUND

As the world becomes entangled in a pandemic, a wide variety of technology has been in development to address the needs to combat the pandemic. One of the needs is to measure body temperatures of people entering specific places (e.g., an administration building, retail stores, offices, MRT stations, etc.) without involving human contact. Therefore, temperature measuring devices have been installed at entrances of those places. In some occasions, forehead thermometers are employed, and everyone entering those places may be instructed to move his/her forehead in front of the forehead thermometers, so as to obtain a temperature on the forehead thereof.

It is noted that accuracy of the measurement of the temperature on the forehead may vary greatly based on a distance between the person and the forehead thermometer. Accordingly, a depth camera or multiple cameras may be disposed near the forehead thermometer so as to obtain the distance between the person and the forehead thermometer.

### SUMMARY

Therefore, an object of the disclosure is to provide a method for measuring distance that can be implemented using a single charge-couple device (CCD) camera.

According to one embodiment of the disclosure, the method is implemented using a processor that executes a software program, and includes:

receiving an image captured by an image capturing device;

identifying and extracting a human face in the image;

identifying two eyes and a mouth included in the human face;

defining a region using the two eyes and the mouth, and calculating a number of pixels contained in the region; and

calculating a distance between the human face and the image capturing device based on the number of pixels contained in the region and a resolution of the image capturing device.

Another object of the disclosure is to provide a system that is capable of implementing the above-mentioned method.

According to one embodiment of the disclosure, the system includes:

an image capturing device configured to capture images; and

an image processing device that is coupled to the image capturing device, and that includes a processor that is programmed to
receive an image captured by the image capturing device;
identify and extract a human face in the image;
identify two eyes and a mouth included in the human face;
define a region using the two eyes and the mouth, and calculate a number of pixels contained in the region; and
calculate a distance between the human face and said image capturing device based on the number of pixels contained in the region and a resolution of said image capturing device.

Another object of the disclosure is to provide a non-transitory computer-readable storage medium that stores instructions that, when executed by a processor, cause the processor to implement steps of the above-mentioned method.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a system for measuring distance according to one embodiment of the disclosure;

FIG. 2 is a flow chart illustrating steps of a method for measuring distance according to one embodiment of the disclosure;

FIG. 3 illustrates an exemplary image that includes a human face, which is identified using the facial landmark model, which may be the Dlib 68 Points Face landmarks Detection Model, but is not limited to the disclosure herein; and

FIG. 4 is a plot showing a number of data points and a linear relationship between a number of pixels under a region and a distance between a human face and an image capturing device.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” may refer to a direct connection among a plurality of electrical apparatus/devices/equipments via an electrically conductive material (e.g., an electrical wire), or an indirect connection between two electrical apparatus/devices/equipments via another one or more apparatus/device/equipment, or wireless communication.

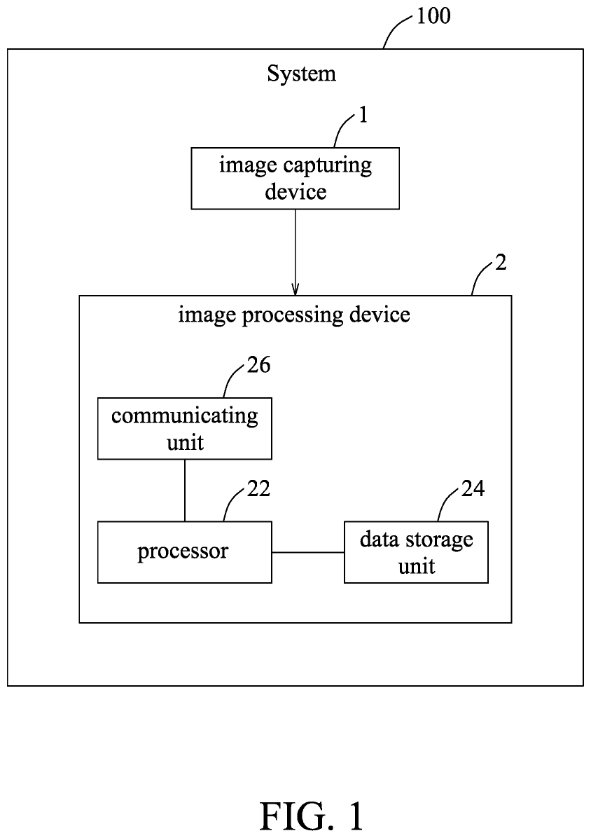

FIG. 1 is a block diagram illustrating a system 100 for measuring distance according to one embodiment of the disclosure. In this embodiment, the system 100 includes an image capturing device 1 and an image processing device 2 that is coupled to the image capturing device 1.

The image capturing device 1 may be embodied using a charge-coupled device (CCD) camera, which has a relatively lower cost to install.

The image processing device 2 includes a processor 22, a data storage unit 24 and a communicating unit 26.

The processor 22 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The data storage unit 24 may be embodied using a memory device such as random access memory (RAM), read only memory (ROM), programmable ROM (PROM), firmware, flash memory, etc. The data storage unit 24 may store a software program including instructions that, when executed by a processor (e.g., the processor 22), cause the processor 22 to implement a number of operations as described below.

The communication unit 26 may include at least one of a radio-frequency integrated circuit (RFIC), a short-range wireless communication module supporting a short-range wireless communication network using a wireless technology of Bluetooth® and/or Wi-Fi, etc., or a mobile communication module supporting telecommunication using Long-Term Evolution (LTE), the third generation (3G) and/or fifth generation (5G) of wireless mobile telecommunications technology, and/or the like.

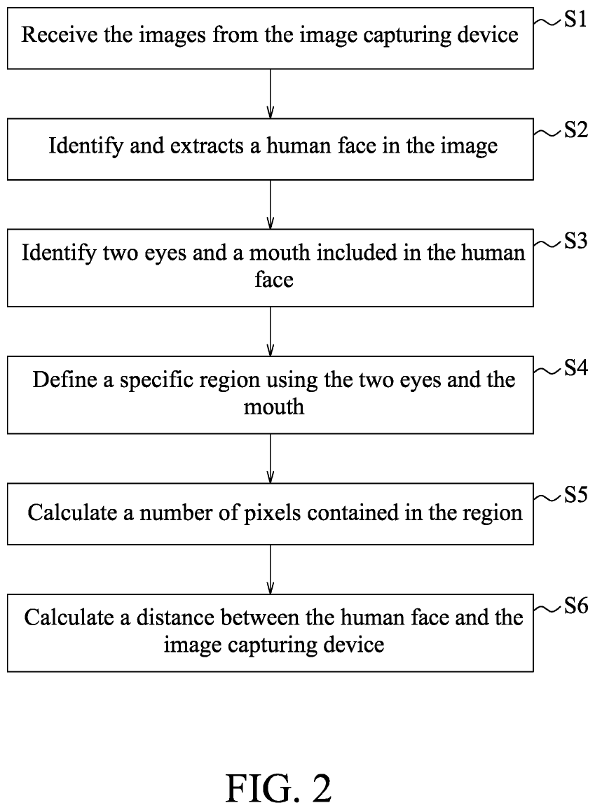

FIG. 2 is a flow chart illustrating steps of a method for measuring distance according to one embodiment of the disclosure. In this embodiment, the method is implemented using the system 100 as shown in FIG. 1.

In use, the system 100 may be installed at a specific location, such as an entrance to a building, a public transit station, a retail store, etc., with a forehead thermometer (not shown), so as to obtain a temperature on a forehead of a person who places his/her forehead in front of the forehead thermometer at a distance of, for example, 3 to 5 centimeters. In this embodiment, the forehead thermometer and the image capturing device 1 are disposed at a height such that most people will be able to place their foreheads in front of the forehead thermometer without excessive effort, and such that the images captured by the image capturing device 1 may contain the faces of the approaching people. For example, the height may be approximately 1.5 meters.

In this embodiment, the system 100 further includes a proximity sensor (not depicted in the drawings) that is coupled to the processor 22, and that may be embodied using an optical proximity sensor. After the system 100 is powered on, the processor 22 is configured to execute the software application, and then activate the proximity sensor.

When the processor 22 determines that an object has come within a pre-determined distance from the system 100 (e.g., within 70 centimeters) according to data from the proximity sensor, in step S1, the processor 22 activates the image capturing device 1 so as to allow the image capturing device 1 to continuously capture images, and receives the images from the image capturing device 1.

For example, the communication unit 26 may be configured to receive the images from the image capturing device 1 and then transmit the images thus received to the processor 22, enabling the processor 22 to perform image processing.

It is noted that in some embodiments, the image capturing device 1 and the image processing device 2 may be embodied using separate devices that are connected via a wired or wireless connection, in which case, the images captured by the image capturing device 1 are transmitted to the image processing device 2 for subsequent processing. Alternatively, the image capturing device 1 and the image processing device 2 may be integrated into a single device.

In step S2, in response to receipt of an image captured by the image capturing device 1, the processor 22 identifies and extracts a human face in the image. In this embodiment, the processor 22 employs an image processing library that is available in the Open Source Computer Vision Library (Open CV) so as to identify and extract the human face, but the manner for identifying and extracting the human face is not limited to such.

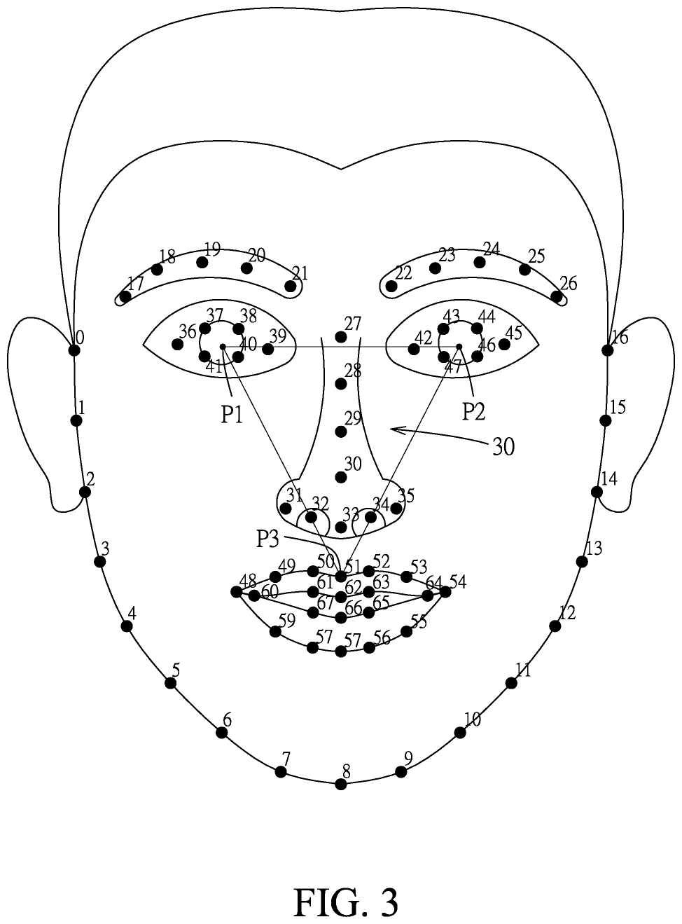

In step S3, the processor 22 identifies two eyes and a mouth included in the human face. In this embodiment, the processor 22 employs the facial landmark model which may be a Dlib 68 Points Face landmarks Detection Model that is programmed in Python and that is available in the Dlib library, but the manner for identifying two eyes and a mouth included in the human face is not limited to the disclosure herein. FIG. 3 illustrates an exemplary image that includes a human face having two eyes and a mouth that are identified using the facial landmark model which may be the 68-landmark face detection model with the resulting sixty-eight numbered landmarks located along contours respectively of the face, and two eyebrows, two eyes, a nose and the mouth (including an upper lip and a lower lip) on the face, but the manner for identifying done by the face detection model is not limited to the disclosure herein.

In step S4, the processor 22 defines a specific region using the two eyes and the mouth identified in step S3.

Specifically, in this embodiment, the processor 22 may first define a centre point of an upper lip of the mouth, and a centre point for each of the two eyes. Using the example of FIG. 3, the upper lip of the mouth may be defined using the landmarks 48 to 54 and 60 to 64, the centre of the upper lip may be defined using the landmark 51 (also labeled P3), the centre point for the left eye may be defined using a center point of a line defined by the landmarks 36 and 39 (labeled P1), and the centre point for the right eye may be defined using a center point of a line defined by the landmarks 42 and 45 (labeled P2). Then, using the three points P1 to P3, the processor 22 defines a triangular region 30 serving as the specific region. It is noted that the defining of the specific region using the two eyes and the mouth is not limited to such.

In step S5, the processor 22 calculates a number of pixels contained in the region 30.

In this embodiment, the processor 22 may first calculate an area of the region 30 using three edges (i.e., the edge P1P2, P1P3 and P2P3) thereof. Specifically, the processor 22 may first determine a length of each of the three edges, and then apply the Heron formula as shown below:

$$\begin{matrix}A = \sqrt{s ( s - a ) ( s - b ) ( s - c )} \\ s = \frac{a + b + c}{2}\end{matrix}$$

where A represents the area, and a, b, c respectively represent the lengths of the three edges. Then, using the area thus calculated, the processor 22 determines how many pixels there are in the region 30. It is noted that the technique used for obtaining the number of pixels in the region 30 is readily known in the art, and details thereof are omitted herein for the sake of brevity.

Then, in step S6, the processor 22 calculates a distance between the human face and the image capturing device 1, based on the number of pixels in the region 30 and a resolution of the image capturing device 1 using a linear equation. Specifically, the distance between the human face and the image capturing device 1 is negatively correlated to the number of pixels in the region 30.

Specifically, the distance is calculated using the following equation:

D=70.949−(0.0013*X*2073600)/Z

where D represents the distance, X represents the number of pixels included in the region 30, and Z represents the resolution of the image capturing device 1.

It is noted that the above-mentioned equation used for calculating the distance between the human face and the image capturing device 1 may be obtained by, prior to the implementation of the method, first capturing a plurality of images each with the person being a specific distance apart from the image capturing device 1, then calculating the number of pixels in the region 30 in each of the images in the same manner as step S5, and then performing a linear regression analysis so as to determine the linear equation that can represent a relationship among the distance between the human face and the image capturing device 1, the number of pixels in the region 30, and the resolution of the image capturing device 1.

The following Table 1 lists the results of the number of pixels in the region 30 in each of the images according to one embodiment of the disclosure, where the resolution of the image capturing device 1 is 1920*1080=2073600.

TABLE 1

| Number of pixels | Distance between the human face |
|---|---|
| in the region | and the image capturing device (cm) |
| 41343 | 30 |
| 35868 | 33 |
| 34665 | 35 |
| 29997 | 38 |
| 26499 | 40 |
| 22736 | 43 |
| 21552 | 45 |
| 19665 | 48 |
| 17596 | 50 |
| 14695 | 53 |
| 13559 | 55 |
| 12622 | 58 |
| 11328 | 60 |
| 10648 | 63 |
| 10032 | 65 |
| 8900 | 68 |
| 8150 | 70 |

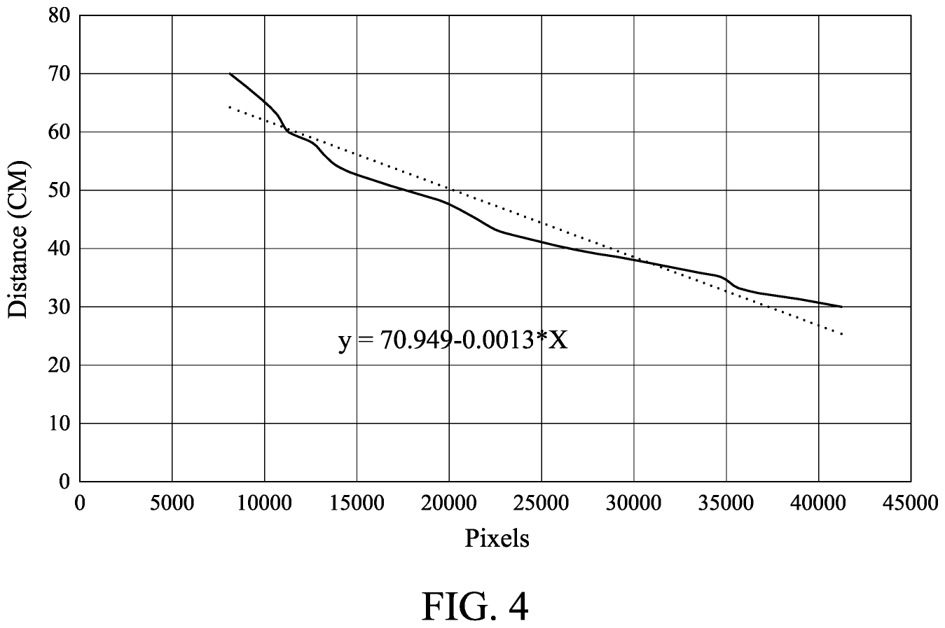

Based on the above numbers, a linear regression analysis (e.g., using Microsoft Excel®) may be performed to determine the linear equation that represents the relationship between the distance between the human face and the image capturing device 1 and the number of pixels in the region 30, given that the resolution of the image capturing device 1 is 1920*1080=2073600. As seen in FIG. 4, the above numbers may be plotted on a chart as data points, and a linear relation (i.e., y=70.949−0.0013*X) and is obtained.

It is noted that for image capturing devices with different resolutions, the above equation may also be adjusted based on the resolution of the image capturing device 1, so as to obtain the following adjusted equation: D=70.949−(0.0013*X*2073600)/Z). As such, when the number of pixels in the region 30 is known for a specific image, the corresponding distance between the human face and the image capturing device I can be calculated, which may then be used to determine whether a temperature on a forehead measured by the forehead thermometer needs to be adjusted based on the distance. This configuration may subsequently improve the accuracy of the measurement of the temperature on a forehead.

According to one embodiment of the disclosure, there is provided a non-transitory computer-readable storage medium that stores instructions that, when executed by a processor, cause the processor to implement steps of a method as shown in FIG. 2.

To sum up, embodiments of the disclosure provide a method, a system and a computer-readable storage medium for measuring a distance between a human face and an image capturing device. By utilizing the method as shown above, the measuring of the distance may be implemented using a single CCD camera, with accuracy that is comparable to using a depth camera or multiple cameras. This enables large scale implementation of the system at a relatively lower cost.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for measuring distance, the method being implemented using a processor that executes a software program, the method comprising:
receiving an image captured by an image capturing device;
identifying and extracting a human face in the image;
identifying two eyes and a mouth included in the human face;
defining a region using the two eyes and the mouth, and calculating a number of pixels contained in the region; and
calculating a distance between the human face and the image capturing device based on the number of pixels contained in the region and a resolution of the image capturing device.

2. The method of claim 1, wherein the identifying of the human face is performed by the processor employing an image processing library.

3. The method of claim 1, wherein:
the identifying of the two eyes and the mouth included in the human face includes employing a face detection model to identify the two eyes and the mouth.

4. The method of claim 3, wherein the defining of the region includes:
defining an upper lip of the mouth, and defining a centre of the upper lip;
defining a centre point for each of the two eyes; and
defining a triangular region that serves as the region using the centre of the upper lip and the centre point for each of the two eyes.

5. The method of claim 1, wherein:
the defining of the region includes defining a triangular region that includes three edges using the two eyes and the mouth; and
calculating a number of pixels contained in the region includes calculating an area of the region using the three edges that define the region, and calculating the number of pixels contained in the region using the area thus calculated.

6. The method of claim 1, wherein the distance is calculated using a linear equation.

7. The method of claim 6, wherein the distance is calculated using the following equation:
D=70.949−(0.0013*2073600*X)/Z
where D represents the distance, X represents the number of pixels contained in the region, and Z represents the resolution of the image capturing device.

8. The method of claim 1, further comprising, prior to receiving the image, steps of:
determining whether an object has come within a pre-determined distance from the image capturing device;
when it is determined that an object has come within the pre-determined distance from the image capturing device, activating the image capturing device to start capturing an image.

9. A system for measuring distance, comprising:
an image capturing device configured to capture images; and
an image processing device coupled to said image capturing device, and including a processor that is programmed to
receive an image captured by said image capturing device;
identify and extract a human face in the image;
identify two eyes and a mouth included in the human face;
define a region using the two eyes and the mouth, and calculate a number of pixels contained in the region; and
calculate a distance between the human face and said image capturing device based on the number of pixels contained in the region and a resolution of said image capturing device.

10. The system of claim 9, wherein said processor is programmed to identify the human face by employing an image processing library.

11. The system of claim 9, wherein said processor is programmed to identify the two eyes and the mouth included in the human face by employing a face detection model.

12. The system of claim 9, wherein said processor is programmed to define the region by:
defining an upper lip of the mouth, and defining a centre of the upper lip;
defining a centre point for each of the two eyes; and
defining a triangular region that serves as the region using the centre of the upper lip and the centre point for each of the two eyes.

13. The system of claim 9, wherein said processor is programmed to define the region by defining a triangular region that includes three edges using the two eyes and the mouth; and
wherein said processor is programmed to calculate the number of pixels contained in the region by calculating an area of the region using the three edges that define the region, and calculating the number of pixels contained in the region using the area thus calculated.

14. The system of claim 9, wherein said processor is programmed to calculate the distance using a linear equation.

15. The system of claim 14, wherein the distance is calculated using the following equation:
D=70.949−(0.0013*2073600*X)/Z
where D represents the distance, X represents the number of pixels contained in the region, and Z represents the resolution of said image capturing device.

16. The system of claim 9, wherein said processor is further programmed to, prior to receiving the image:
determine whether an object has come within a pre-determined distance from said image capturing device;
when it is determined that an object has come within the pre-determined distance from said image capturing device, activate said image capturing device to start capturing an image.

17. A non-transitory computer-readable storage medium that stores instructions that, when executed by a processor, cause the processor to implement steps of the method of claim 1.
